(19) United States
(12) Patent Application Publication
(10) Pub. No.: US 2017/0090268 A1
(43) Pub. Date: Mar. 30, 2017

(54) CHIRP SUPPRESSED RING RESONATOR

(71) Applicant: Maurice Stephen O'Sullivan, Ottawa (CA)

(72) Inventor: Maurice Stephen O'Sullivan, Ottawa (CA)

(73) Assignee: Ciena Corporation, Hanover, MD (US)

(21) Appl. No.: 14/871,625

(22) Filed: Sep. 30, 2015

(51) Int. Cl. G02F 1/225

(52) U.S. Cl. CPC G02F 1/2257; G02F 2001/212

(57) ABSTRACT

An optical modulator may include a first interferometer arm and a second interferometer arm, a first microring resonator disposed along the first interferometer arm, the first microring resonator having a first resonant wavelength, and the first resonant wavelength having a first difference from a carrier wavelength. The optical modulator may include a second microring resonator disposed along the second interferometer arm, the second microring resonator having a second resonant wavelength, and the second resonant wavelength having a second difference from the carrier wavelength. The difference between the first and second resonant wavelengths and the carrier wavelength defines a first and second microring resonator detuning, respectively. The second microring resonator detuning and the first microring resonator detuning have opposite signs. The optical modulator may include a first modulation line electrically connected to the first microring resonator, and a second modulation line electrically connected to the second microring resonator.

### BACKGROUND

In modern optical telecommunications systems, information encoded in a digital electrical signal is modulated onto an optical carrier. The modulated optical carrier (and therefore the information it contains) may then be transported through the larger telecommunications network by way of infrastructure of optical links (e.g., optical fibers) and nodes (e.g., optical switches, optical add drop multiplexors, or the like). To maximize data throughput, modern telecommunications systems employ not just one optical carrier, but several independent optical carriers each having a different wavelength. In such systems, each optical carrier may be independently encoded with data and the several modulated optical carriers may be multiplexed and sent down the same optical link. This technique that employs multiple carrier wavelengths to increase data throughput is known as wavelength divisional multiplexing (“WDM”). In WDM systems constant pressure exists to increase the total number of wavelength channels used and also to decrease the respective spectral spacing between channels. For example, today's typical WDM systems may employ up to 160 independent wavelength channels centered near 1.5 μm and separated by 100 GHz, 50 GHz, or even 25 GHz. Expectations are that future systems may use a higher number of more densely spaced wavelength channels.

Each individual optical carrier may be modulated by a number of different ways. For example, the amplitude and/or frequency of the carrier may be modulated directly at the light source, e.g., a laser diode-based source may be modulated by directly modulating its drive current. Other examples include external modulators that modulate the carrier after it has left the source laser. Examples of these types of external modulation techniques include the use of one or more electro-optic modulators that use the external electrical signal that is encoded with the digital data to modulate the optical properties (amplitude, frequency, and/or phase) of an optical element placed within the optical link. Of particular importance in WDM systems is that such modulators should operate at a high bandwidth, as it relates to the direct modulation of the optical property by the electronic signal, and should also allow for independent modulation of each carrier wave at its respective wavelength without significantly affecting nearby (i.e., spectrally close) WDM channels.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to an optical modulator including a first interferometer arm and a second interferometer arm, a first microring resonator disposed along the first interferometer arm, the first microring resonator having a first resonant wavelength, and the first resonant wavelength having a first difference from a carrier wavelength. The first difference between the first resonant wavelength and the carrier wavelength defines a first microring resonator detuning. The optical modulator includes a second microring resonator disposed along the second interferometer arm, the second microring resonator having a second resonant wavelength, and the second resonant wavelength having a second difference from the carrier wavelength. The second difference between the second resonant wavelength and the carrier wavelength defines a second microring resonator detuning. The second microring resonator detuning and the first microring resonator detuning have opposite signs. The optical modulator may further include a first modulation line electrically connected to the first microring resonator, and a second modulation line electrically connected to the second microring resonator. The first resonant wavelength depends on a first modulation signal provided by the first modulation line, and the second resonant wavelength depends on a second modulation signal provided the second modulation line.

In general, in one aspect, one or more embodiments relate to a method of modulating an optical signal including a carrier wave having a carrier wavelength. The method includes receiving, by an input optical waveguide, the optical input signal, transmitting, by the input optical waveguide, the input optical signal to a beamsplitter, splitting, by the beamsplitter, the input optical signal into a first optical signal travelling in a first interferometer arm and a second optical signal travelling in a second interferometer arm, coupling a portion of the first optical signal into a first microring disposed along the first interferometer arm, coupling a portion of the second optical signal into a second microring disposed along the second interferometer arm, and modulating effective refractive indices of the first microring and the second microring, according to a first electrical modulation signal and a second electrical modulation signal. The first electrical modulation signal and the second electrical modulation signal depend on an input data stream. Modulating effective refractive indices encodes the input data stream onto the carrier wavelength and generates a first modulated optical signal and a second modulated optical signal. The first microring has a first resonant wavelength having a first difference from the carrier wavelength. The first difference between the first resonant wavelength and the carrier wavelength defines a first microring resonator detuning. The second microring has a second resonant wavelength having a second difference from the carrier wavelength. The second difference defines a second microring resonator detuning. The first microring resonator detuning and the second microring resonator detuning have opposite signs. The method may further include recombining, by a beam combiner, the first modulated optical signal and the second modulated optical signal to generate a modulated output optical signal travelling in an output optical waveguide.

In general, in one aspect, one or more embodiments relate to an apparatus including a first optical I-Q modulator including a first input optical waveguide that receives a first wavelength division multiplexed optical input signal, and a first beamsplitter having an input end and an output end. The input end of the first beamsplitter is optically connected to the first input optical waveguide. The output end of the beamsplitter is optically connected to the input end of a first interferometer arm and the input end of a second interferometer arm. The first optical I-Q modulator may further include a first amplitude modulator disposed along the first interferometer arm. The first amplitude modulator includes a first set of microrings. The first optical I-Q modulator may include second amplitude modulator disposed along the second interferometer arm. The second amplitude modulator includes a second set of microrings. The first optical I-Q modulator may include a first optical phase delay element disposed along the second interferometer arm, and a first beam combiner having an input end and an output end. The input end of the first beam combiner is optically connected to the output end of the first interferometer arm and the output end of the second interferometer arm. The output end of the first beam combiner is optically connected to a first output optical waveguide.

Other aspects of the invention will be apparent from the following description and the appended claims.

### BRIEF DESCRIPTION OF DRAWINGS

FIG. 1 shows an electro-optical modulation system in accordance with one or more embodiments.

FIGS. 2A and 2B show a microring, a simulated optical response of the microring, and a simulated optical response of a microring-based Mach-Zehnder interferometer in accordance with one or more embodiments.

FIG. 3 shows a microring-based Mach-Zehnder modulator in accordance with one or more embodiments.

FIGS. 4A, 4B, and 4C show a microring-based Mach-Zehnder modulator and a chirp free modulation technique in accordance with one or more embodiments.

FIG. 5 shows a method of chirp free modulation using a microring-based Mach-Zehnder modulator in accordance with one or more embodiments.

FIG. 6 shows an I-Q modulator employing multiple microring-based Mach-Zehnder interferometer modulators in accordance with one or more embodiments.

FIGS. 7 and 8 show example modulation drive hardware in accordance with one or more embodiments.

FIG. 9 shows an example silicon-on-insulator (SOI) implementation of a microring modulator in accordance with one or more embodiments.

FIG. 10A shows a multi-wavelength amplitude modulator in accordance with one or more embodiments.

FIGS. 10B and 10C show multi-wavelength I-Q amplitude modulators in accordance with one or more embodiments.

### DETAILED DESCRIPTION

Specific embodiments of a chirp suppressed ring resonator will now be described in detail with reference to the accompanying figures Like elements in the various figures (also referred to as FIGs.) are denoted by like reference numerals for consistency.

In the following detailed description of embodiments, numerous specific details are set forth in order to provide a more thorough understanding of chirp suppressed ring resonator. However, it will be apparent to one of ordinary skill in the art that these embodiments may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention relate to electro-optic modulators for optical communications. More specifically, one or more embodiments are directed to amplitude modulators that employ microring resonators in a Mach-Zehnder interferometer. In a typical microring modulator, the amplitude response is inextricably tied to the phase response which results in a frequency chirp being imparted to the light being modulated. This frequency chirp generally limits the application of microring based devices to intensity modulation direct detection (“IMDD”) links with low chromatic dispersion and makes it almost unusable for the quality of field modulation required for coherent transceiver applications. However, one or more embodiments of the modulators described herein strongly suppress the chirp of a microring-based modulator. Furthermore, because the frequency chirp may be nearly eliminated, one or more embodiments may be employed in coherent modulation schemes.

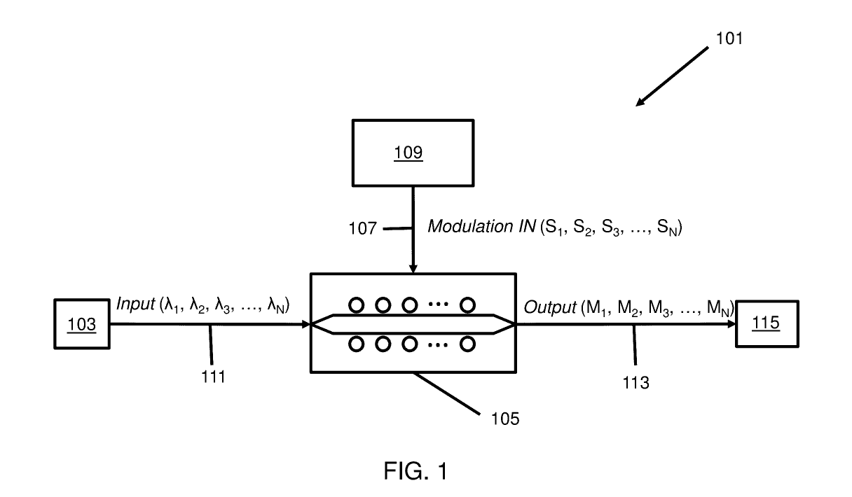

FIG. 1 shows a WDM electro-optical modulation system 101 in accordance with one or more embodiments. The system includes a WDM light source 103 optically connected to optical modulator 105. In accordance with one or more embodiments, the WDM light source 103 may be any WDM source that produces an optical WDM output signal that includes individual wavelength channels λ₁, λ₂, λ₃, . . . , λ_{N}. Optical modulator 105 receives an electrical modulation signal S₁, S₂, S₃, . . . , S_{N} 107 that originates from an electrical modulation source 109. In accordance with one or more embodiments, the electrical modulation signal includes a multitude of electrical signals, each encoded with data that is to be modulated onto a respective WDM channel. Optical modulator 105 modulates these digital data onto the WDM carriers of the optical input signal 111 resulting in a modulated output signal M₁, M₂, M₃, . . . , M_{N} 113.

In accordance with one or more embodiments, and as shown in FIG. 1 and explained in more detail below, the optical modulator 105 may be an integrated Mach-Zehnder interferometer having two interferometer arms, with pairs of microring resonators cascaded along the length of the interferometer arms. As explained in more detail below, such an architecture allows for a microring-based electro-optic modulator that is capable of modulating the amplitude of the individual channels that may span a wide range of carrier wavelengths while at the same time minimizing the frequency distortions commonly endemic to microring resonator-based electro-optic modulators. These frequency distortions often serve to take an initially spectrally narrow WDM channel and broaden or otherwise distort the frequency distribution of the channel, a phenomena referred to herein as “chirp.”

After modulation by the optical modulator 105, the modulated output signal 113 may then be further routed through the network, e.g., to optical node 115, for any purpose. Accordingly, the optical node device 115 may be any optical node device known in the art, e.g., a device used to detect, route, modify, and/or demultiplex a WDM signal. Furthermore, the embodiments of the present invention are not limited to the configuration shown in FIG. 1 as it is provided here merely for the sake of example. Any configuration for the system may be used, including the addition, subtraction, or rearrangement of one or more optical elements, without departing from the scope of the present disclosure.

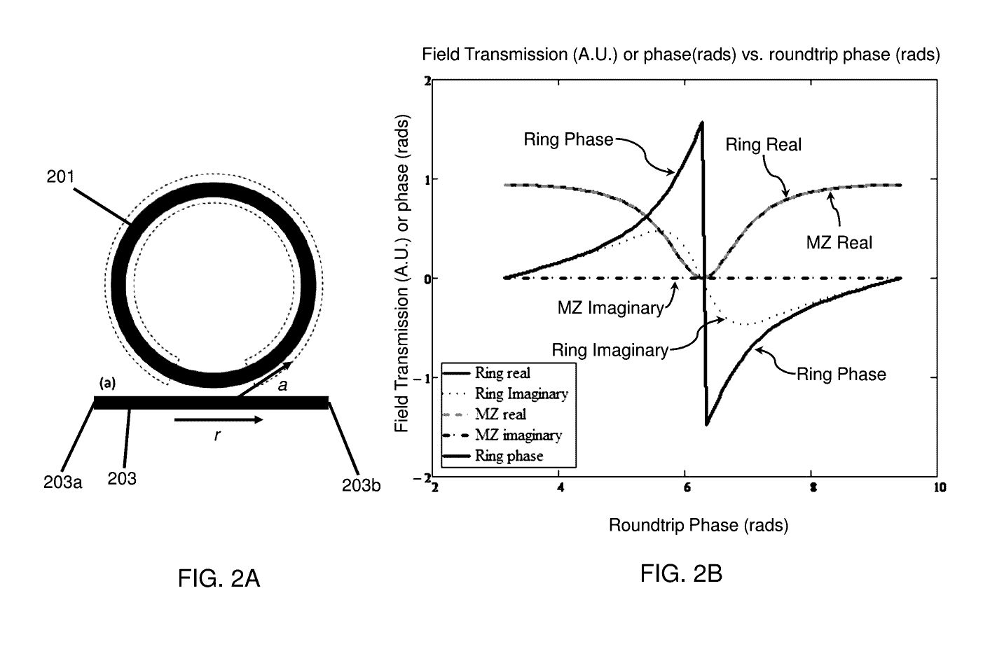

FIG. 2A shows one example of a microring modulator, like that used within modulator 105, in accordance with one or more embodiments of the invention. The microring modulator includes a loop-shaped optical waveguide (microring 201) coupled to a planar optical waveguide (bus waveguide 203). In general, a microring resonator coupled to a planar optical waveguide such as that shown in FIG. 2A operates as what is referred to as an “all-pass” optical filter. In such a device, all of the WDM channels being guided from the input port 203a to the output port 203b of the bus waveguide 203 passes by the microring 201 unaffected, except for WDM channels having a wavelength that is very close to the resonance wavelength of the microring, e.g., WDM channels having wavelengths that are centered at or within the linewidth of the microring resonance may be attenuated. Therefore, as is described in detail below, modulation of a given WDM channel may be achieved by modulating the resonance frequency of the microring, e.g., by electrically modifying the optical properties of the ring.

Before the details of this electro-optic modulation are discussed, a more detailed discussion of the resonance properties of a microring resonator is described. For the single ring arrangement shown in FIG. 2A, the transmitted amplitude Eₚₐₛₛ is related to the input amplitude Eᵢₙₚᵤₜ by the relation Eₚₐₛₛ=E(φ, r, a)·Eᵢₙₚᵤₜ, where E(φ, r, a) is the field transfer function, given by:

$$E ( φ , r , a ) = {e}^{i ( π + φ )} \frac{a - r {e}^{- iφ}}{1 - ra {e}^{iφ}} \qquad ( 1 )$$

where φ is the single pass phase shift, i.e., the phase shift picked up by the light after travelling once around the ring, i.e., the circumference of the ring, and β is the propagation constant of the light circulating in the ring. The parameter β is given by

$$β = ( \frac{2 π}{{λ}_{o}} ) {n}_{eff} ,$$

with λ₀ being the free space wavelength and n_{eff} being the effective refractive index of the ring modulator. The effective refractive index n_{eff} is related to the phase velocity c of the circulating light by c=c₀/n_{eff}, where co is the speed of light in vacuum. The constant r is the self-coupling coefficient and a is the single pass amplitude transmission. Physically, r is related to how much light is coupled through the bus waveguide relative to how much is coupled into the microring. The parameter a is related to the absorption of the circulating light by the microring waveguide material and is related to the microring power attenuation coefficient α by way of the relation a²=e^{-αL} where L is the round trip length.

For non-zero values of a, light that is coupled into the microring 201 is eventually absorbed resulting in a corresponding loss of transmission through bus waveguide 203. Maximum coupling of light from the bus waveguide 203 to the microring 201 is achieved for “on resonance” light that has a wavelength (within the ring material) that is an integer multiple of the optical length of the ring. This resonance condition is given by

$${λ}_{res} = \frac{{n}_{eff} L}{m} , where m = 1 , 2 , 3 , … .$$

In particular, when the coupled power into the ring is equal to the power loss of the ring, a condition known as critical coupling, occurring when r=a, the transmission through the bus waveguide 203 drops to zero if one of the resonance conditions, e.g., for the lowest order m=0 mode, above is met. In such a case, the resonance, or near resonance, absorption of the microring is related to the real part of the field transfer function Eq. (1). The real part of the field transfer function Eq. (1) as a function of the round trip phase φ is shown as the Ring Real Curve of FIG. 2B.

For a fixed microring round trip length, L, the roundtrip phase φ is determined by the propagation constant

$$β = ( \frac{2 π}{{λ}_{o}} ) {n}_{eff}$$

and thus, may be tuned by varying the effective refractive index of the ring n_{eff}. As described in more detail below, the electro-optic modulator in accordance with one or more embodiments of the invention achieves modulation of the light by modulating n_{eff} by modulating the electrical properties of the microring waveguide material.

Returning to Eq. (1) it can be seen that the field transfer function E(φ, r, a) is a complex quantity (it has both real and imaginary parts) and thus, any modulation of φ produces a modulation of both the amplitude and the phase of the light that passes through the bus waveguide 203. The amplitude modulation may be adequately described by the real part of the field transfer function and is shown by the resonant absorption of the ring already discussed above in reference to the Ring Real Curve of FIG. 2B. The phase modulation behavior of a single microring is related to the imaginary part of the field transfer function and is also shown in FIG. 2B as the Ring Phase Curve.

The phase modulation induced by the single microring resonator is detrimental to optical communications schemes because it leads to a frequency chirp within the any modulated WDM channel. Coupled with the inherent dispersion characteristics of most optical fibers (dispersion being a frequency dependent velocity of the optical signal), a frequency chirp in any WDM channel leads to a spatial dispersion (or spreading) of the signal along the length of the fiber as the signal travels along the fiber. Historically, the chirp problem has limited the use of microring resonator-based amplitude modulators to short-run applications because of the inter-symbol interference that occurs due to this chirp/dispersion interaction.

In accordance with one or more embodiments, the electro-optic modulator described herein provides for a microring-based modulator having reduced and/or completely suppressed chirp. The chirp suppression is accomplished through a design that employs a micro-ring Mach-Zehnder (“MRMZ”) modulator, as described in detail below. The MRMZ architecture employs balanced pairs of microrings that cooperatively modulate each WDM channel, one microring in a first arm of the interferometer inducing a+φ round trip phase and another corresponding microring in the second arm of the interferometer inducing a−φ round trip phase, when modulated by the same data stream. Thus, when combined at the output of the interferometer, such an arrangement produces a field transfer function having the following form:

MZ(φ, r, a)=½E₁(φ, r, a)+E₂(−, r, a) (2)

where E₁ is the single microring transfer function of the light passing through the first interferometer arm and E₂ is the single microring transfer function of the light passing through the second interferometer arm.

The MZ Imaginary Line of FIG. 2B plots the imaginary part of Eq. (2), showing that in such a configuration, the imaginary part of the combined response of both rings is always zero because the imaginary parts of each ring response are precisely equal and opposite and therefore cancel. Likewise, the MZ Real Curve of FIG. 2B plots the real part of Eq. (2), for equal optical amplitudes in each interferometer arm and for a=0.7 and r=0.7. The plot shows that the real part of the field transfer function in the paired ring case is identical to the single ring case. Accordingly, the total response of the MRMZ modulator purely a real quantity and therefore does not impart any frequency chirp onto the WMD channel being modulated, but instead produces a pure amplitude modulation without any phase altering effects.

Accordingly, because the modulation is accomplished without a significant modulation of the phase, the MRMZ modulator in accordance with one or more embodiments may be employed in coherent systems that rely on phase locked control of the electric field over the entire spectrum of WDM channels, e.g., through the use of an optical comb source. Furthermore, the narrow spectral widths of the individual microring resonances may be fully exploited. For example, as described below, several pairs of microrings may be cascaded along the length of the interferometer arms, each allowing for independent modulation of one WDM channel. Because the microrings can be designed with spectrally narrow resonances, off-resonance transmission may be very nearly 100 percent, meaning that only wavelength channels in the near vicinity of the resonance are affected while all others pass substantially unmodulated, thereby reducing cross-talk between WDM channels. Of course, one of ordinary skill in the art will appreciate that the degree to which the chirp may be reduced depends on a number of physical constraints on the system design and thus, the idealized description above of perfect amplitude modulation should not be used to limit the scope of the invention in any way.

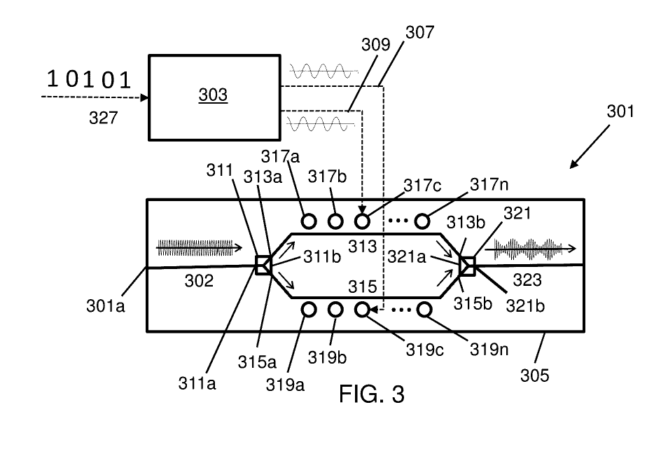

FIG. 3 shows a block diagram of an electro-optical modulator in accordance with one or more embodiments. More specifically, FIG. 3 shows a MRMZ modulator 301 electrically connected to a modulation driver 303 by way of modulations lines 307 and 309. In accordance with one or more embodiments, the MRMZ modulator 301 may be fabricated as an integrated optical circuit on a monolithic substrate 305, e.g., a silicon substrate. At the input end 301a of the modulator 301 is an input optical waveguide 302 that is optically connected to an input end 311a of a first beamsplitter 311. Several examples of implemented integrated beamsplitters include a y-branch, a 2×2 coupler, and a multimode interference coupler. In the example y-branch, an input waveguide feeds two output waveguides emerging from the output waveguide's intersection at an angle bisected by the input direction. In the example 2×2 coupler, two input waveguides are brought into proximity for some propagation length such that evanescent coupling between waveguides in the region of proximity allows transfer of optical power between waveguides. In the example multimode interference coupler, the input waveguide couples to a multimodal waveguide region whose dimensions are arranged to provide good coupling with equal power into two output single mode waveguides. The examples above impart a phase difference of π/2 radians between the fields of the two output waveguides. The 2×2 coupler may be more wavelength sensitive than the y-branch and the multi-mode interference coupler. The output end 311b of the first beamsplitter 311 is connected to the input ends 313a and 315a of two additional optical waveguides that form a first arm 313 and a second arm 315 of a Mach-Zehnder interferometer. Placed in series along the first and second interferometer arms 313 and 315 are one or more microring resonators 317a-n and 319a-n, respectively, which may each be formed as ring-shaped integrated optical waveguides of an electro-optic material. These microring resonators, while shown as having a circular shape in this example, may be any closed shape without departing from the scope of the present disclosure, e.g., oblong, elliptical, racetrack, or the like.

In accordance with one or more embodiments, each microring resonator is placed in close proximity to its respective interferometer arm waveguide to allow for the guided optical wave within the interferometer arm to be optically coupled to the microring resonator, e.g., by way of evanescent coupling. In accordance with one or more embodiments, the microring resonators 317a-n and 319a-n are fabricated to have resonant frequencies that are spectrally near the WDM channels desired to be modulated, as described below. Furthermore, each microring on the first arm 313 has a corresponding microring on the second arm 315 that are both used to modulate the same WDM carrier signal using the same data stream. For example, FIG. 3 shows that microring 317c on interferometer arm 313 and microring 319c on interferometer arm 315 are both designed to have a resonant wavelength near one of the WDM channels being modulated, e.g., λ₃. Accordingly, the pair of electrical modulation lines 307 and 309 are each respectively electrically connected to the microrings 317c and 319c such that the modulation signals on the first and second modulation lines serve to encode the input data 305 onto the WDM channel having wavelength λ₂. In a similar manner, each of the microring pairs 313a-319a, 313b-319b, 313c-319c, . . . , 313n-319n can each be used to modulate one of the a WDM channels having wavelengths λ₁, λ₂, λ₃, . . . , λₙ, respectively.

The output end 313b of the first interferometer arm 313 and the output end 315b of the second interferometer arm 315 are optically connected to the input end 321a of output beam combiner 321 that serves to recombine the modulated beams and may, e.g., be a beamsplitter similar to input beamsplitter 311 but arranged in reverse (inputs and outputs flipped). Connected to the output end 321b of output beam splitter 321 is output optical waveguide 323, which guides the modulated optical signal out of the modulator.

Any number of different types of optical interconnects (not shown) may be used to couple the optical input signal into the input optical waveguide 302 and likewise to out-couple the modulated output optical signal from the output optical waveguide 323. Furthermore, any number of optical modulators and or other integrated optical components may precede or follow the optical modulator 301 without departing form the scope of the present disclosure.

In accordance with one or more embodiments, the modulation driver 303 receives an input data stream 327 that is to be modulated onto a particular WDM channel by a given microring pair. For simplicity, the modulation driver is shown in FIG. 3 as having only two output modulation lines, but any number of lines may be used (two for each WDM channel to be modulated) without departing from the scope of the present disclosure. In addition, while the modulation lines are illustrated by single line, the type of interconnect may vary with the design being implemented, e.g., coaxial cables, stripline interconnects, or any other suitable interconnect technology may be used, and single ended, differential drive, or any other technique may be used to drive each line without departing from the scope of the present disclosure. Furthermore, the modulation driver may be any signal generator that can receive a frequency division multiplexed electrical signal, demodulate that signal, mix down or up the signal (if necessary), and transform the received signal into a set of drive signals to be sent to the microring modulators in order to encode the optical carrier waves that include the input WDM signal with the data stream 327. Accordingly, the modulation driver includes the necessary processors, memory, multiplexers, demultiplexers, mixers, signal generators, transmission lines, etc. that are commonly used to drive electro-optical modulators.

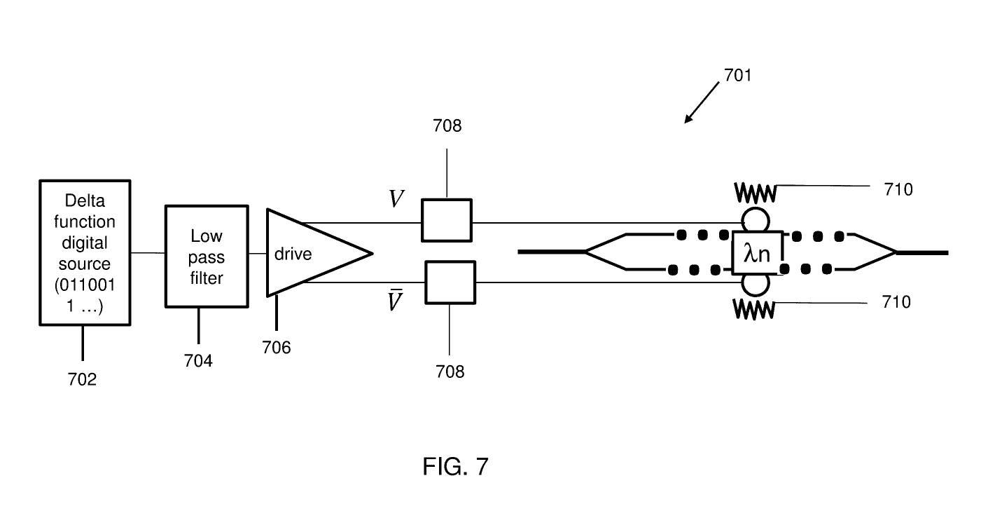

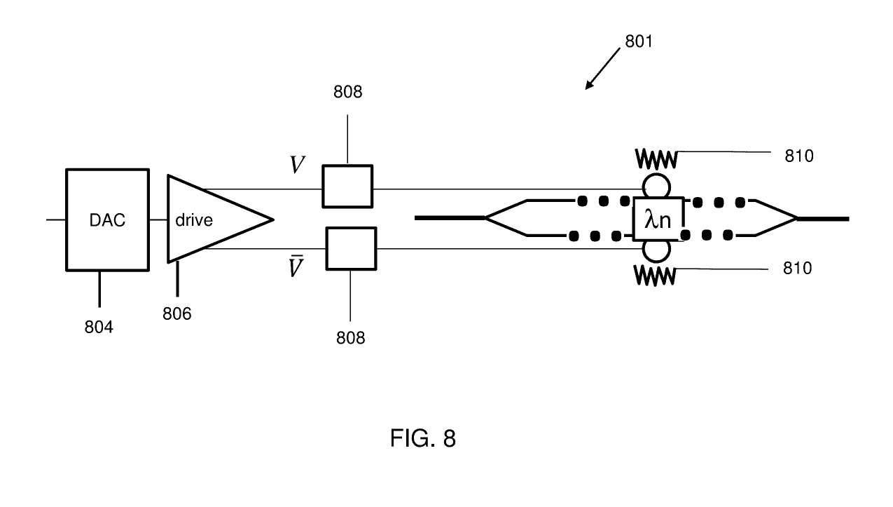

Two example drive schemes are shown in FIGS. 7 and 8. FIG. 7 illustrates driver hardware (per X) 701, where a digital instruction 702 (delta impulse function) is shaped by a low pass filter 704 and amplified by a driver 706 with differential output. Each output may be alternating current (AC) coupled to a ring modulator drive electrode. A drive electrode delivers an electrical signal to affect the ring structure resonance. An electrical bias 708 may be combined with the drive signal by the bias tee as shown in FIG. 7. Alternately, the bias objective can be achieved by other means such as temperature (thermal bias 710). FIG. 8 illustrates a second drive scheme using the same ring bias methods. The driver hardware 801 of FIG. 8 is per λ, per phase, and per polarization, where a digital instruction is converted to an analog drive signal by means of a digital to analog converter (DAC) 804. The signal is subsequently amplified by a driver 806 with differential output as in FIG. 7, where the bias objective may be achieved via an electrical bias 808 or a thermal bias 810. The drive scheme of FIG. 7 may be a low cost intensity modulation with differential drive, where tuning is based on thermal bias 708, carrier density bias 710, and/or other electro-optics. The drive scheme of FIG. 8 may be an electric field modulator with substantially independent control of optical field amplitude and phase. In the schemes of both FIGS. 7 and 8 many wavelengths, co-propagating at the input to the Mach Zehnder waveguide may be simultaneously modulated by cascading tuned ring pairs along the M-Z arms. The simultaneous modulation may be substantially simultaneous. In some embodiments, the modulation is concurrent modulation.

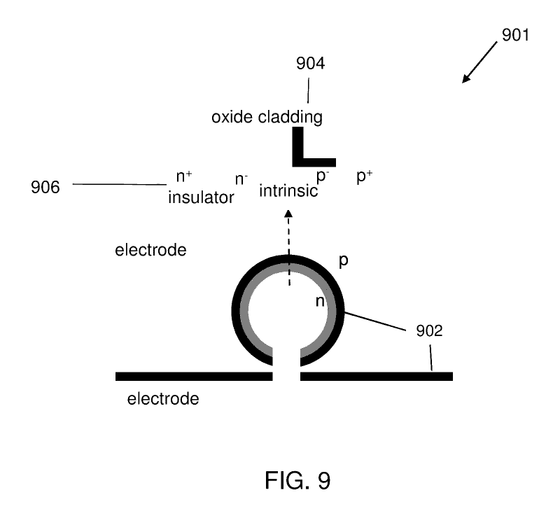

In accordance with one or more embodiments, the MRMZ modulator may be implemented as an integrated optical circuit on a substrate 305. For example, the substrate may be indium phosphide (InP), an insulator such as SiO₂ or sapphire on Silicon, with the optical waveguide elements formed from InP based quaternary, silicon, silicon nitride, or other material using some combination of implantation, in-diffusion, etch, molecular bonding, growth and regrowth processes. The individual microrings may be formed from similar materials using similar processes forming structures that allow for electrical signals from the various modulation lines to be connected and used to individually modify the effective index of refraction n_{eff}, thereby affecting the modulation. For example, as shown in FIG. 9, such a microring modulator may have a silicon on insulator (SOI) implementation 901 (e.g., see insulator 906 in FIG. 9) with the ring core 904 comprising a p-i-n or p-n junction. In these cases, the n_{eff} of the ring core material may be modified by electrically manipulating the carrier density (electrons and holes) at the junction using the voltage provided by the modulation lines. For example, in the p-i-n configuration, forward biasing the junction causes carriers to be injected into the core, strongly affecting n_{eff} Likewise, for p-n implementation, the carrier density within the junction may be modified by reverse-biasing the junction to increase or decrease the depletion region in the ring core, thereby affecting n_{eff}. In accordance with one or more embodiments, any suitable semi-conductor material may also be heterogeneously introduced into the microrings and/or waveguide material 902 (a cross-sectional view is shown in 904), e.g., by heterogeneously introducing III-V semiconductors in the silicon or by fabricating the entire waveguide structure in the III-V material of choice. In general, however, the embodiments of the invention are not limited to a particular type of substrate, material, or fabrication process and the above is provided merely for the sake of example.

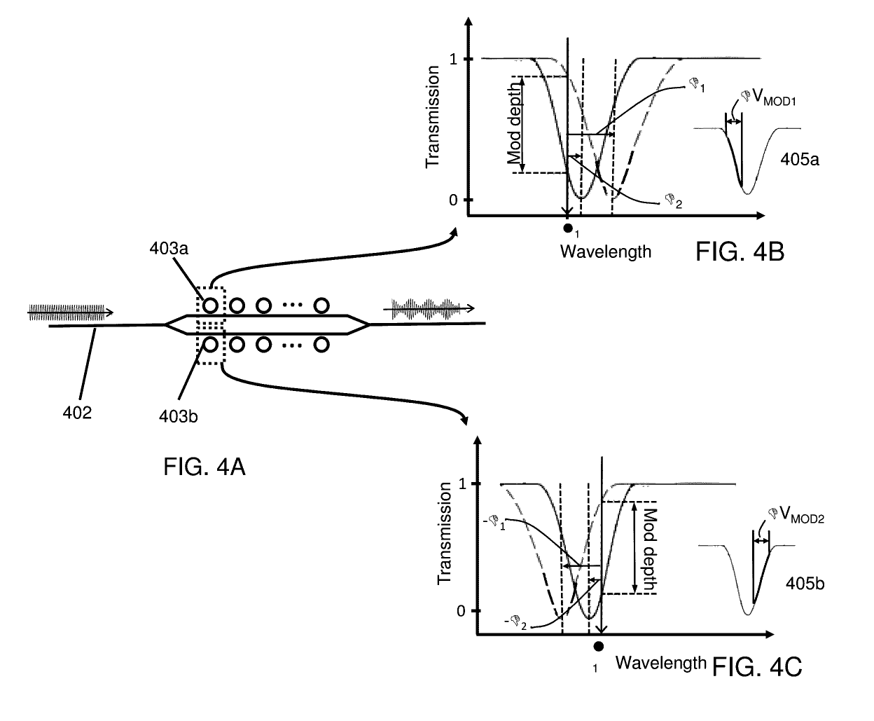

FIGS. 4A, 4B, and 4C show a modulation technique used that may be used to suppress chirp in the modulated output signal of the MRMZ modulator in accordance with one or more embodiments. As already described above in reference to FIG. 3, a WDM optical input signal is input on input optical waveguide 402. In this example, the WDM signal input to the input optical waveguide 402 includes a number of unmodulated carrier wavelength channels (WDM channels) λ₁, λ₂, λ₃, . . . , λₙ. The MRMZ modulator therefore includes n pairs of microring modulators, each pair being dedicated to the modulation of one of the WDM channels. For the sake of simplicity, the description of the modulation process below considers only the first pair of rings 403a-403b used to modulate the WDM channel having a wavelength λ₁. However, this process may be employed for any number of microrings without departing from the scope of the present disclosure.

As shown in the plots of FIGS. 4B and 4C, both the rings 403a and 403b may have respective resonances near λ₁. However, the rings are designed such that during modulation, the resonant frequencies of the two rings straddle the carrier wavelength For example, during modulation, the resonance of ring 403a may always be at a wavelength that is shorter than λ₁. This ensures that during modulation, the voltage change ΔV_{MOD1} (which may originate from one of the modulation lines, e.g., as shown in FIG. 3) causes the modulation to be localized to the left, or leading, side (short wavelength side) of the microring resonance as shown in the inset 405a of FIG. 4B. Likewise, during modulation, the resonance of ring 403b may always be at a wavelength that is longer than λ₁. This ensures that during modulation, the voltage change ΔV_{MOD1} (which may originate from one of the modulation lines, e.g., as shown in FIG. 3) causes the modulation to be localized to the left, or trailing, side (long wavelength side) of the microring resonance as shown in the inset 405b of FIG. 4C.

As used herein, the term detuning, signified by the symbol Δ is used to refer to the instantaneous difference between the carrier wavelength λ₁ and the wavelength of the ring resonance λ_{ring}, i.e., Δ=λ₁−λ_{ring}(V), where the position of the ring resonance λ_{ring} depends on the instantaneous value of the modulation voltage V, as shown by the transmission functions plotted in FIGS. 4B and 4C, respectively. Thus, in this example, the detuning of ring 403a is always negative during modulation and the detuning of ring 403b is always positive during modulation. As already described above, after being modulated by rings 403a and 403b, the WDM channel at is recombined by an output beam combiner, as shown in FIGS. 2 and 3. Referring back to Eqs. (1)-(2), in order to cancel the imaginary component of the field transfer function, it is desirable that the single pass phases φ of the two modulators be equal and opposite, which, assuming that the two rings resonances are of identical shape, means that the instantaneous detunings of the microrings during modulation should have an opposite sign and a substantially equal magnitude, i.e.,

Δ₁(t)≈−Δ₂(t) for all t (3)

Of course, Eq. (3) is merely the condition for perfect chirp suppression and the present disclosure is not limited to require that the equality provided above be always strictly met. In addition, by purposefully tuning the modulation voltages to deviate from Eq. (3) above, a predetermined chirp may be built into the system design, if desired. Furthermore, if the two resonances are not precisely the same shape, the respective detunings may not be precisely equal to achieve the equal and opposite phases φ between the two rings. In this case, the rings transfer functions may be measured in advance to determine an appropriate compensation signal to be applied with the modulation signals so that the chirp may be sufficiently suppressed, even in the presence of imperfections and/or asymmetries between the pair of microrings.

Returning to the plots shown in FIGS. 4B and 4C, it can be seen that the amplitude modulation in each interferometer arm is accomplished by tuning the resonance of the microrings 403a and 403b such that the carrier wavelength λ₁ is effectively scanned across the inner and outer slopes, respectively of the resonance lineshapes. In accordance with one or more embodiments, maximum attenuation (i.e. the “off” or “0” state) of the WMD channel may be accomplished at a detuning from resonance of Δ₁ (−Δ₁), as shown by the solid lines in FIGS. 4B and 4C. Likewise, the minimum attenuation (i.e., the “on” or “1” state) may be accomplished at a detuning from resonance of Δ₂ (−Δ₂), as shown by the dashed lines in FIGS. 4B and 4C. Accordingly, the total modulation depth is determined by the attenuation difference between these two detunings, as shown in FIGS. 4B and 4C.

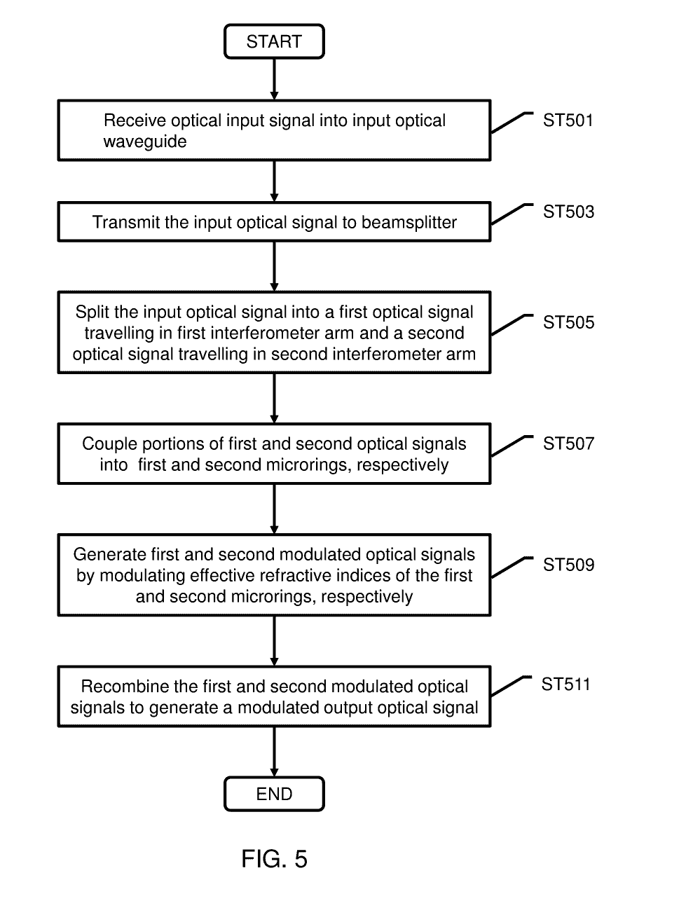

FIG. 5 shows a chirp reducing method of modulating an optical signal using a MRMZ modulator in accordance with one or more embodiments. For example, such a method may be implemented by the modulator systems described above in reference to FIGS. 1, 2A, 2B, 3, 4A, 4B, and 4C.

In ST501, an optical input signal is received by an input optical waveguide. The optical input signal may be a WDM optical input signal that includes several wavelength channels, as described above in reference to FIG. 3. In ST503, the input optical signal is transmitted to a beamsplitter, e.g., beamsplitter 311 of FIG. 3, where, in ST505, the input optical signal is split to form a first optical signal travelling in a first interferometer arm and a second optical signal travelling in a second interferometer arm. The first and second interferometer arms may be arranged in a Mach-Zehnder configuration, e.g., like arms 313 and 315 of MRMZ modulator 301, described above in reference to FIG. 3. As described above, in accordance with one or more embodiments, the entire optical system may be formed as an integrated optical circuit on a monolithic substrate, e.g., silicon, or the like.

In ST507, portions of the first and second optical signals are coupled into a first and a second microring, respectively, each microring respectively disposed along the first interferometer arm between the beamsplitter and a beam combiner, e.g., as shown above in FIG. 3. The coupling may be accomplished, e.g., by evanescent coupling or any other suitable optical coupling mechanism.

In ST509, the effective refractive indices of the first and second microrings are modulated according to a first and a second electrical modulation signal, respectively, e.g., as described above in reference to FIGS. 4A, 4B, and 4C. In order to affect the chirp free modulation at the output of the MRMZ modulator, the pair of electrical modulation signals used to drive the pair of rings are set by the same input data so as to encode the input data stream onto the carrier wavelength that corresponds to the resonant wavelength of the microring pair. However, the electrical modulation signals are not identical but are chosen to modulate each ring such that the WDM channel being modulated is either modulated by the leading edge or trailing edge of the corresponding ring optical response function, e.g., as described above in reference to FIG. 2B and FIGS. 4B and 4C. More specifically the electrical modulation signals are such that they produce equal but opposite single-pass phases φ (and thus, imaginary components of the modulated field) in each of the first and second optical signals. In accordance with one or more embodiments, this equal but opposite response may be accomplished by setting, during modulation, the first microring resonator detuning to be substantially equal and of opposite sign to the second microring resonator detuning, as described above in reference to FIGS. 4A, 4B, and 4C.

In ST511, the beam combiner recombines the first modulated optical signal and the second modulated optical signal travelling in the first and second interferometer arms, respectively, to generate a modulated output optical signal travelling in an output optical waveguide. As already alluded to above, the beam combiner has the effect of adding together the two modulated signals from the respective interferometer arms and because the imaginary component of the modulation signal in one arm is substantially equal and opposite to the imaginary component of the modulation signal in the other arm, the imaginary component cancels after recombination. Thus, the modulation of the modulated output optical signal travelling in an output optical waveguide is purely real and the chirp is substantially suppressed.

While the above method is described using an example of a single microring pair being used to modulate a single WDM channel, one or more embodiments may employ a cascaded set of several microring pairs to independently modulate any number of WDM channels. In particular, because each modulation is substantially chirp free and because each microring resonance may be made relatively narrow spectrally (i.e., high Q), one or more embodiments may be used to independently modify the amplitude of the WDM channels, thereby only minimally affecting the phase coherence between WDM channels. Thus, the MRMZ modulator described herein may be employed in any number of coherent optical modulation schemes.

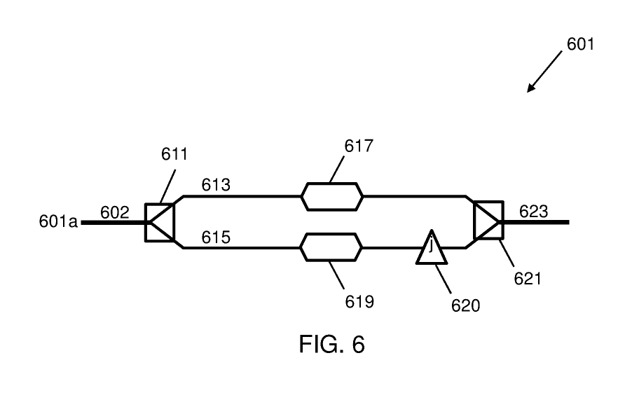

FIG. 6 shows an example of an I-Q modulator 601 formed from two MRMZ modulators in accordance with one or more embodiments. The MRMZ modulators may be like those described above in reference to FIGS. 1, 2A, 2B, 3, 4A, 4B, and 4C and thus may serve to modulate the amplitudes of several WDM channels while leaving the phase of the channels substantially unaffected.

The I-Q modulator of FIG. 6 has a Mach-Zehnder interferometer architecture. On the input end 601a of the interferometer is an input optical waveguide 602 that is optically connected to an input end of a first beamsplitter 611. The output end of the first beamsplitter 611 is connected to the input end of two additional optical waveguides that form a first arm 613 and a second arm 615 of the Mach-Zehnder interferometer. Positioned within the first arm 613 is first MRMZ modulator 617 that modulates the amplitude of the portion of the input optical signal that travels through first arm 613. Thus, the output of the MRMZ modulator 617 serves as the “in-phase” modulated component of the I-Q modulator. Positioned within the second arm 615 is second MRMZ modulator 619 that modulates the amplitude of the portion of the input optical signal that travels through second arm 615. Also located within second arm 615 is optical phase delay element 620 that serves to shift the phase of the modulated optical signal in second arm 615 by 90 degrees (π/2 radians) thereby creating the “at quadrature” component of the I-Q modulation scheme. The phase delay may be implemented with a section of waveguide whose optical distance (effective index) is controlled lithographically (by choice of physical length), electrically (choice of carrier density and/or applied electric field) or thermally (by temperature dependent effective index). The phase may be under active control to keep the phase's value fixed over changing environmental conditions.

The output ends of the first interferometer arm 613 and second interferometer arm 615 are joined at output beam combiner 621, which may, e.g., be another beamsplitter arranged in reverse (inputs and outputs flipped) as compared to the input beamsplitter 611. Connected to the output end of output beam splitter 621 is output optical waveguide 623 which guides the I-Q modulated optical signal 625 out of the modulator.

In accordance with one or more embodiments, the above I-Q modulator based on MRMZ modulators may be implemented in any coherent scheme because the MRMZ modulators themselves provide amplitude-only modulation. For example, the I-Q modulator described herein may be used to modulate all or part of a comb source whose individual subcarriers are phase-locked and equally spaced. In such an embodiment, the individual microring resonators within each MRMZ modulator may be designed with low enough order of resonance such that no higher order resonance is contained within the portion of the comb spectrum to be modulated. Thus, a cascade of triple MZ (TMZ) IQ modulators based on ring resonators, one TMZ for each subcarrier with a modulation bandwidth proportional to the subcarrier spacing would allow phase locked control of the electric field over the continuous spectrum spanned by the portion of the comb source.

In one or more embodiments, the π/2 phase delay may be subcarrier dependent with attendant quadrature error. The attendant quadrature error over the C-band may be of order of approximately 1 degree and may be repaired at the transmitter or receiver. A disturbance of neighboring carriers may also exist by the extended effect of the modulation of a ring on any given carrier. The disturbance may set a limit on the number of subcarriers that can be acted on by a triple M-Z.

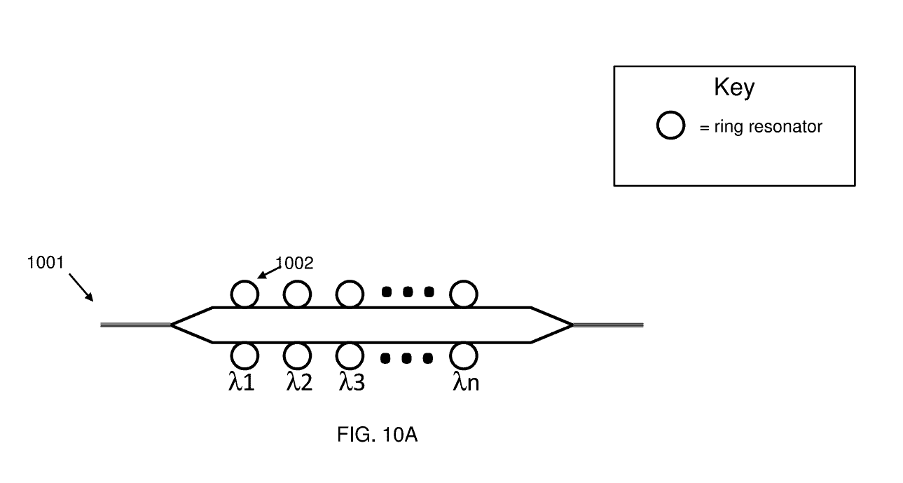

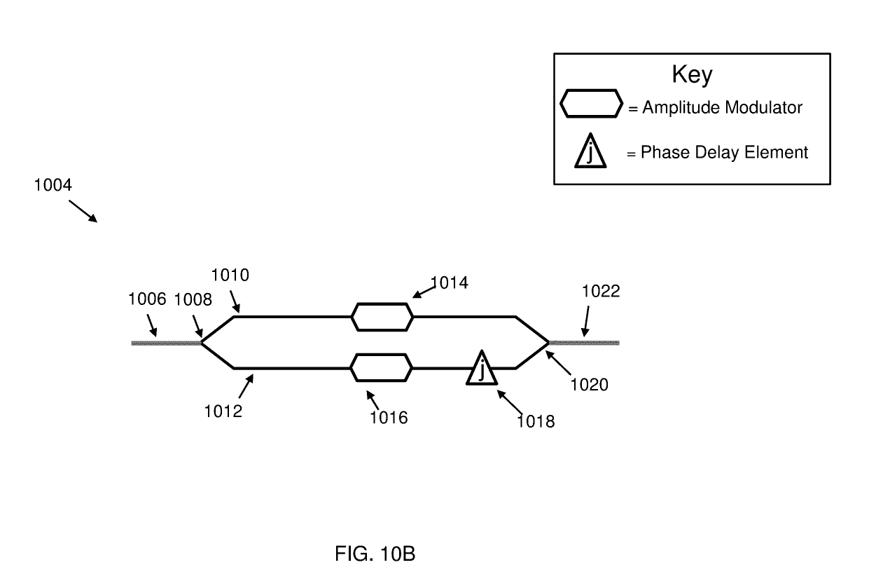

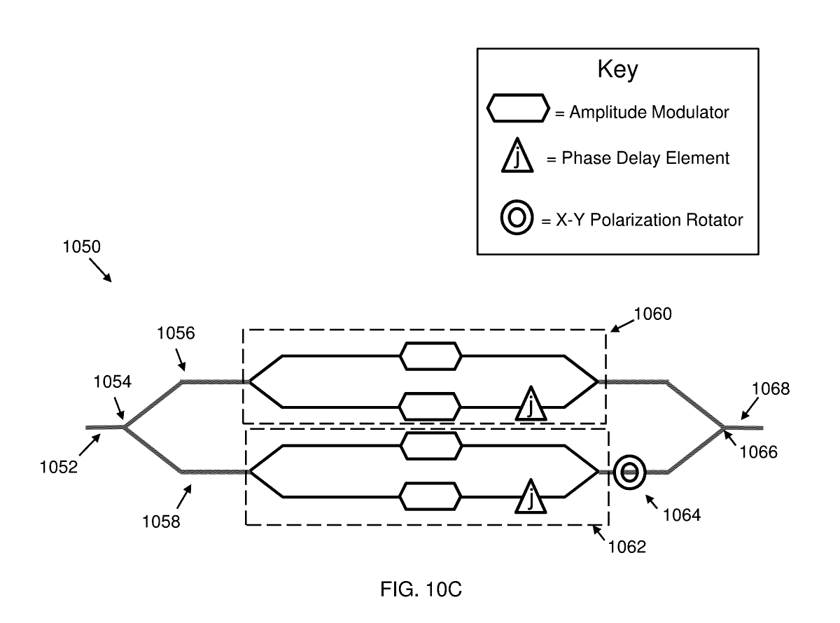

FIG. 10A illustrates one or more embodiments of a multi-wavelength amplitude modulator 1001. As shown in FIG. 10A, the multi-wavelength amplitude modulator 1001 may include ring resonators 1002. The ring resonators may be in series. In FIG. 10A, the three solid collinear dots mean additional ring resonators may be included without departing from the scope of the invention.

FIG. 10B shows an I-Q modulator 1004 in accordance with one or more embodiments of the invention. The I-Q modulator 1004 may include an input optical waveguide 1006 that receives a wavelength division multiplexed optical input signal. The input optical waveguide 1006 is optically connected to a beamsplitter 1008 having an input end and an output end. The output end of the beamsplitter 1008 is optically connected to the input end of a first interferometer arm 1010 and the input end of a second interferometer arm 1012. The I-Q modulator 1004 may further include a first amplitude modulator 1014 disposed along the first interferometer arm 1010, and a second amplitude modulator 1016 disposed along the second interferometer arm 1012. The amplitude modulators (e.g., first amplitude modulator 1014, second amplitude modulator 1016) may correspond to the amplitude modulator 1001 shown in FIG. 10A. Disposed along the second interferometer arm may be an optical phase delay element 1018. The phase delay element may introduce an approximately π/2 phase delay in accordance with one or more embodiments of the invention. The I-Q modulator 1004 may include a beam combiner 1020 having an input end and an output end. The input end of the beam combiner 1020 is optically connected to the output end of the first interferometer arm 1010 and the output end of the second interferometer arm 1012. The output end of the beam combiner 1020 is optically connected to a first output optical waveguide 1022.

FIG. 10C shows an X-Y, I-Q modulator 1050 in accordance with one or more embodiments of the invention. The X-Y, I-Q modulator 1050 may be used with a comb laser to combine WDM, electro-optical DAC multiplexing, and I-Q modulation, and also reduce the loss of cascade. In one or more embodiments of the invention, the X-Y, I-Q modulator 1050 may include an input optical waveguide 1052 that receives a wavelength division multiplexed optical input signal, and a beamsplitter 1054 having an input end and an output end. The input end of the beamsplitter 1054 is optically connected to the input optical waveguide 1052. The output end of the beamsplitter 1054 is optically connected to an input end of a first interferometer arm 1056 and an input end of a second interferometer arm 1058. Disposed on the first interferometer arm 1056 and the second interferometer arm 1058 may be a first I-Q modulator 1060 and a second I-Q modulator 1062, respectively. The I-Q modulators may each correspond to the I-Q modulator 1004 shown in FIG. 10B in accordance with one or more embodiments of the invention. A polarization rotator 1064 may also be along the second interferometer arm 1058. The polarization rotator 1064 may be a X-Y polarization rotator in accordance with one or more embodiments of the invention. The X-Y, I-Q modulator 1050 may include a beam combiner 1066 having an input end and an output end. The input end of the beam combiner 1066 may be optically connected to the output end of the first interferometer arm 1056 and the output end of the second interferometer arm 1058. The output end of the beam combiner 1066 may be optically connected to an output optical waveguide 1068.

One or more of the above embodiments may also be implemented in polarization diverse modulation schemes. For example, in accordance with one or more embodiments, a modulator operating on a second polarization could be arranged by replicating the multi-wavelength modulator cascade and combining one output with the polarization rotator 1064 that is rotated along a second interferometer arm 1058, as shown in FIG. 10C Again, because of the amplitude only modulation of the individual MRMZ modulators, such a system could also be suitable for coherent applications.

Although FIGS. 10A, 10B, and 10C show a certain configuration of components, other configurations may exist without departing from the scope of the invention. For example, additional beamsplitters, amplitude modulators, beam combiners, other components of FIGS. 10A, 10B, and 10C, and/or other components that are not shown may be included in the various embodiments without departing from the scope of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An optical modulator comprising:
a first interferometer arm and a second interferometer arm;
a first microring resonator disposed along the first interferometer arm, the first microring resonator having a first resonant wavelength, the first resonant wavelength having a first difference from a carrier wavelength, wherein the first difference between the first resonant wavelength and the carrier wavelength defines a first microring resonator detuning;
a second microring resonator disposed along the second interferometer arm, the second microring resonator having a second resonant wavelength, the second resonant wavelength having a second difference from the carrier wavelength, wherein the second difference between the second resonant wavelength and the carrier wavelength defines a second microring resonator detuning,
wherein the second microring resonator detuning and the first microring resonator detuning have opposite signs;
a first modulation line electrically connected to the first microring resonator; and
a second modulation line electrically connected to the second microring resonator,
wherein the first resonant wavelength depends on a first modulation signal provided by the first modulation line, and the second resonant wavelength depends on a second modulation signal provided by the second modulation line.

2. The optical modulator of claim 1, wherein the first microring resonator detuning is positive and the second microring resonator detuning is negative.

3. The optical modulator of claim 1, wherein the first microring resonator detuning is negative and the second microring resonator detuning is positive.

4. The optical modulator of claim 1, wherein an absolute value of the first microring resonator detuning is substantially equal to an absolute value of the second microring resonator detuning.

5. The optical modulator of claim 1, wherein absolute values of both the first microring resonator detuning and the second microring resonator detuning are reduced in response to a modulation signal from the first modulation line and the second modulation line, respectively.

6. The optical modulator of claim 1, wherein absolute values of both the first microring resonator detuning and the second microring resonator detuning are increased in response to a modulation signal from the first modulation line and the second modulation line, respectively.

7. The optical modulator of claim 1, further comprising:
an input optical waveguide that receives an optical input signal, the optical signal comprising light having the carrier wavelength;
a beamsplitter having an input end and an output end,
wherein the input end of the beamsplitter is optically connected to the input optical waveguide,
wherein the output end of the beamsplitter is optically connected to an input end of the first interferometer arm and is optically connected to an input end of the second interferometer arm, and
wherein the beamsplitter splits the optical input signal into a first optical signal travelling in the first interferometer arm and a second optical signal travelling in the second interferometer arm; and
a beam combiner having an input end and an output end,
wherein the input end of the beam combiner is optically connected to an output of the first interferometer arm and is also optically connected to an output of the second interferometer arm,
wherein the output end of the beam combiner is optically connected to an output optical waveguide, and
wherein the beam combiner recombines the first optical signal and the second optical signal into a modulated output optical signal travelling in the output optical waveguide.

8. A method of modulating an optical signal comprising a carrier wave having a carrier wavelength, the method comprising:
receiving, by an input optical waveguide, the optical input signal;
transmitting, by the input optical waveguide, the input optical signal to a beamsplitter;
splitting, by the beamsplitter, the input optical signal into a first optical signal travelling in a first interferometer arm and a second optical signal travelling in a second interferometer arm;
coupling a portion of the first optical signal into a first microring disposed along the first interferometer arm;
coupling a portion of the second optical signal into a second microring disposed along the second interferometer arm;
modulating effective refractive indices of the first microring and the second microring, according to a first electrical modulation signal and a second electrical modulation signal, wherein the first electrical modulation signal and the second electrical modulation signal depend on an input data stream, wherein modulating effective refractive indices encodes the input data stream onto the carrier wavelength and generates a first modulated optical signal and a second modulated optical signal,
wherein the first microring has a first resonant wavelength having a first difference from the carrier wavelength, wherein the first difference between the first resonant wavelength and the carrier wavelength defines a first microring resonator detuning, wherein the second microring has a second resonant wavelength having a second difference from the carrier wavelength, wherein the second difference defines a second microring resonator detuning, and
wherein the first microring resonator detuning and the second microring resonator detuning have opposite signs; and
recombining, by a beam combiner, the first modulated optical signal and the second modulated optical signal to generate a modulated output optical signal travelling in an output optical waveguide.

9. The method of claim 8, wherein the first microring resonator detuning is positive and the second microring resonator detuning is negative.

10. The method of claim 8, wherein the first microring resonator detuning is negative and the second microring resonator detuning is positive.

11. The method of claim 8, wherein an absolute value of the first microring resonator detuning is substantially equal to an absolute value of the second microring resonator detuning.

12. The method of claim 8, wherein absolute values of both the first microring resonator detuning and the second microring resonator detuning are reduced in response to the electrical modulation signals from the first modulation line and second modulation line, respectively.

13. The method of claim 8, wherein absolute values of both the first microring resonator detuning and the second microring resonator detuning are increased in response to the electrical modulation signals from the first modulation signal and second modulation signal, respectively.

14. An apparatus comprising:
a first optical I-Q modulator comprising:
a first input optical waveguide that receives a first wavelength division multiplexed optical input signal;
a first beamsplitter having an input end and an output end,
wherein the input end of the first beamsplitter is optically connected to the first input optical waveguide,
wherein the output end of the beamsplitter is optically connected to the input end of a first interferometer arm and the input end of a second interferometer arm, and
a first amplitude modulator disposed along the first interferometer arm, wherein the first amplitude modulator comprises a first plurality of microrings;
a second amplitude modulator disposed along the second interferometer arm, wherein the second amplitude modulator comprises a second plurality of microrings;
a first optical phase delay element disposed along the second interferometer arm; and
a first beam combiner having an input end and an output end,
wherein the input end of the first beam combiner is optically connected to the output end of the first interferometer arm and the output end of the second interferometer arm, and
wherein the output end of the first beam combiner is optically connected to a first output optical waveguide.

15. The apparatus of claim 14, the first amplitude modulator further comprising a Mach-Zehnder interferometer that comprises the first plurality of microrings.

16. The apparatus of claim 15, the second amplitude modulator further comprising a Mach-Zehnder interferometer that comprises the second plurality of microrings.

17. The apparatus of claim 15, wherein the first optical I-Q modulator further comprises a plurality of drives to the first amplitude modulator and the second amplitude modulator, wherein the plurality of drives are prepared to correct for residual phase modulation by the amplitude modulators.

18. The apparatus of claim 15, wherein at least one of the first plurality of microrings are tuned according to a microring tuning process comprising a first part and a second part, and wherein the first part is controlled by a bias actuation and the second part is controlled by a modulation actuation, and wherein the first part is slower than the second part.

19. The apparatus of claim 14, wherein the first I-Q modulator is comprised in an optical X-Y, I-Q modulator, wherein the first I-Q modulator is disposed along a third interferometer arm, and wherein the optical X-Y, I-Q modulator further comprises:
a second input optical waveguide that receives a second wavelength division multiplexed optical input signal;
a second beamsplitter having an input end and an output end,
wherein the input end of the second beamsplitter is optically connected to the second input optical waveguide,
wherein the output end of the second beamsplitter is optically connected to an input end of the third interferometer arm and an input end of a fourth interferometer arm, and
a second I-Q modulator disposed along the fourth interferometer arm;
a first polarization rotator along the second interferometer arm; and
a second beam combiner having an input end and an output end,
wherein the input end of the second beam combiner is optically connected to the output end of the third interferometer arm and the output end of the fourth interferometer arm, and
wherein the output end of the second beam combiner is optically connected to a second output optical waveguide.

20. The apparatus of claim 19, wherein the second I-Q modulator comprises:
a third input optical waveguide that receives the wavelength division multiplexed optical input signal;
a third beamsplitter having an input end and an output end,
wherein the input end of the third beamsplitter is optically connected to the second input optical waveguide,
wherein the output end of the third beamsplitter is optically connected to an input end of a fifth interferometer arm and an input end of a sixth interferometer arm, and
a third amplitude modulator disposed along fifth interferometer arm, wherein the third amplitude modulator comprises a third plurality of microrings;
a fourth amplitude modulator disposed along the sixth interferometer arm, wherein the fourth amplitude modulator comprises a fourth plurality of microrings;
a second optical phase delay element disposed along the sixth interferometer arm; and
a third beam combiner having an input end and an output end,
wherein the input end of the third beam combiner is optically connected to the output end of the fifth interference arm and the output end of the sixth interferometer arm, and
wherein the output end of the third beam combiner is optically connected to a second output optical waveguide.
